(19) United States
(12) Patent Application Publication
(10) Pub. No.: US 2007/0095587 A1
(43) Pub. Date: May 3, 2007

(54) Hybrid vehicle drive train and method

(75) Inventor: Leonard DuCharme, American Fork, UT (US)

Correspondence Address: DAVID R. MCKINNEY, P.C., 8 EAST BROADWAY, SUITE 500, SALT LAKE CITY, UT, 84111, US

(73) Assignee: Hybrid Dynamics Corp.

(21) Appl. No.: 11/592,428

(22) Filed: Nov. 3, 2006

Related U.S. Application Data
(60) Provisional application No. 60/732,613, filed on Nov. 3, 2005.

(51) Int. Cl. B60L 8/00

(52) U.S. Cl. 180/65.3

(57) ABSTRACT

A drive train for a hybrid vehicle having first, second and third motors includes a first variable transmission, having an input shaft, and an output shaft coupled to a drive wheel of the vehicle, and first, second, and third clutched rotational drive connections. The rotational drive connections selectively interconnect an output shaft of the first, second and third motors, respectively, with the input shaft of the first transmission, whereby torque from each of the three motors can be selectively combined through the variable transmission to drive the drive wheel.

### PRIORITY CLAIM

The present application claims priority to U.S. Provisional patent application Ser. No. 60/732,613, filed Nov. 3, 2005, and entitled DRIVE TRAIN OF A HYBRID VEHICLE UTILIZING A HYDRAULIC MOTOR, AN ELECTRIC MOTOR, AND AN INTERNAL COMBUSTION ENGINE.

### BACKGROUND

1. Field of the Invention

The present invention relates generally to drive trains for hybrid vehicles. More particularly, the present invention relates to a drive train for a hybrid vehicle that uses three drive motors: a hydraulic motor, an electric motor, and an internal combustion engine.

2. Related Art

Hybrid motor vehicles—vehicles utilizing an internal combustion engine in combination with an electric motor—have become increasingly popular and more widely commercially available in recent years. More broadly, any type of vehicle that combines two or more types of power is considered to be a hybrid vehicle. Hybrid vehicles offer several advantages over other types of vehicles. For example, purely electric vehicles require no fossil fuels (directly), but have significant range limitations—they will only go a relatively short distance before a lengthy recharging cycle is necessary. In contrast, internal combustion engine-powered vehicles have much less significant range limitations (especially given the wide availability of gasoline or diesel fuel), but produce greenhouse gases and, with the increasing cost of fossil fuels, are increasingly expensive to operate. By combining the benefits of each type of power source, hybrid vehicles overcome the range limitation of electric vehicles, and effectively increase the efficiency of the internal combustion engine. In short, hybrid vehicles use less fuel than comparable vehicles powered only by an internal combustion engine.

There are two main types of hybrid vehicles: parallel hybrids and series hybrids. Parallel hybrids include at least two different drive motors that can propel the vehicle independently of one another or in tandem. For example, a gasoline engine and an electric motor can both be connected to a transmission, with a control system that determines which motor should be used at a given time. A series hybrid vehicle, on the other hand, includes at least two different motors, but only one is used to propel the vehicle. For example, one type of series hybrid includes an electric motor and an internal combustion engine. However, the electric motor is used exclusively to power the vehicle, while the internal combustion engine is used in conjunction with a generator to recharge the battery or to supply electricity directly to the electric motor.

Both parallel and series hybrid systems have advantages over either purely electric vehicles or internal combustion engine vehicles. However, these two types of hybrid vehicles still have limitations, and the improvement in fuel economy that they provide is still relatively modest.

### SUMMARY

It has been recognized that it would be advantageous to develop hybrid vehicles that are more fuel-efficient and utilize propulsion systems under conditions that are closer to the most efficient operational parameters of the systems.

In accordance with one aspect thereof, the invention provides a hybrid vehicle drive train including a first variable transmission, having an input shaft, and an output shaft coupled to a drive wheel of the vehicle, and a plurality of motors, independently operable at varying rotational rates. A mechanical coupling connects an output shaft of each of the plurality of motors to the input shaft of the first transmission, whereby torque from each of the plurality of motors can be selectively combined through the first transmission to drive the drive wheel.

In accordance with another aspect thereof, the invention provides a drive train for a hybrid vehicle having first, second and third motors. The drive train includes a first variable transmission, having an input shaft and an output shaft, the output shaft being coupled to a drive wheel of the vehicle. First, second, and third clutched rotational drive connections are provided to selectively interconnect an output shaft of the first, second and third motors, respectively, with the input shaft of the first transmission, whereby torque from each of the three motors can be selectively combined through the variable transmission to drive the drive wheel.

In accordance with another aspect thereof, the invention provides a drive train for a hybrid vehicle having first, second and third motors. The drive train includes a drive shaft, connected to a drive wheel of the vehicle, and first, second, and third rotational drive connections, selectively interconnecting an output shaft of the first, second and third motors, respectively, with the drive shaft. First, second, and third variable transmissions are interposed within the first second and third rotational drive connections, respectively, and are configured to match a speed of rotation of the respective motor with a speed of rotation of the drive shaft, whereby torque from each of the three motors can be selectively combined through the variable transmission to drive the drive wheel.

In accordance with yet another aspect thereof, the invention provides a method for interconnecting multiple torque sources operating at independent speeds to drive a common output shaft. The method includes the steps of interconnecting each of the multiple torque sources to a common input shaft via an individual clutched rotational drive connection associated with each torque source, and modulating rotation of the output shaft via a variable transmission connected to the common input shaft, whereby torque from each of the multiple torque sources can be selectively combined through the variable transmission to drive the common output shaft.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a schematic diagram of one embodiment of a hybrid vehicle drive train in accordance with the present disclosure;

FIG. 2 is a schematic diagram of an alternative embodiment of a hybrid vehicle drive train utilizing a variable transmission inline between the electric motor and the main transmission;

FIG. 3 is a schematic diagram of another alternative embodiment of a hybrid vehicle drive train utilizing a variable transmission inline between the electric motor and the main transmission, and a variable transmission inline between the internal combustion engine and the main transmission; and

FIG. 4 is a schematic diagram of yet another alternative embodiment of a hybrid vehicle drive train utilizing a variable transmission inline between the electric motor and the jackshaft, a variable transmission inline between the internal combustion engine and the jackshaft, and a third variable transmission inline between the hydraulic motor and the jackshaft.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides a drive train for a hybrid vehicle that allows multiple motors to be used under conditions that are closer to their most efficient operational parameters. The invention takes advantage of improvements that have been made in recent years in variable transmissions, such as continuously variable and infinitely variable transmissions. The invention provides a mechanical architecture that allows multiple motors to drive a common transmission. This approach simplifies the drive train and can significantly improve drive train efficiency.

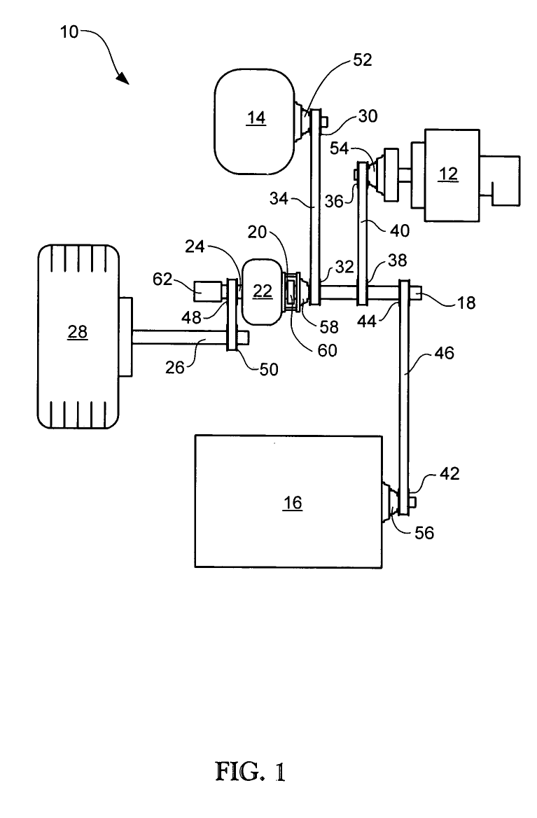

Shown in FIG. 1 is a schematic diagram of one embodiment of a hybrid vehicle drive train 10 having three drive motors: a hydraulic motor 12, an electric motor 14, and an internal combustion engine 16. The term “motor” is used herein to designate any type of motor or engine, as those terms are understood in the mechanical arts. Additionally, while they are not shown, it will be understood that each motor is presumed to include the appropriate input energy source. Specifically, the internal combustion engine is presumed to include a motor fuel input source and air intake, the electric motor is presumed to be attached to a source of electrical power, and the hydraulic motor is presumed to be associated with a high pressure fluid source. The three motors are mechanically coupled to a jackshaft 18, which is an extension of an input shaft 20 of a first or main transmission 22. The output shaft 24 of the main transmission is mechanically coupled to a drive shaft 26, which in turn is connected to a wheel 28 of the vehicle, allowing the main transmission to transmit driving torque to the drive wheel. As with the motors, it will be appreciated that other structures, such as universal joints, bearings, etc, that are well known and used to couple a drive shaft to a wheel are presumed to be associated with the drive shaft, although these are not shown in the figures.

The mechanical coupling of the motors and other components in the drive train can be accomplished in a variety of ways. In the embodiments shown in FIGS. 1-4, the various motors are coupled to the jackshaft 18 via a drive belt and pulley system. For example, viewing FIG. 1, the electric motor 14 includes a pulley 30 that is coupled to a corresponding pulley 32 on the jackshaft 18 via an endless belt (e.g. a V-belt) 34. Likewise, the hydraulic motor 12 includes a pulley 36 that is coupled to another pulley 38 mounted on the jackshaft via a second V-belt 40, and the internal combustion engine 16 includes a pulley 42 that is coupled to another pulley 44 mounted on the jackshaft via a third V-belt 46. In the embodiment of FIGS. 1-4 the output shaft of the main transmission also includes a pulley 48 that is connected to a corresponding pulley 50 on the drive shaft 26.

The output shaft of each of the three drive motors includes an engagement device that is operable to selectively engage the respective motor with its associated mechanical coupling to the jackshaft. In one embodiment the engagement device can be a clutch, such as a magnetic clutch. Specifically, the electric motor 14 can include a magnetic clutch 52 that selectively engages the pulley 30 of the electric motor. Likewise, the hydraulic motor 12 can include a magnetic clutch 54 for engaging its pulley 36, and the internal combustion engine can include a magnetic clutch 56 for engaging its pulley 42. When the clutch for a given motor is not engaged, the corresponding pulley can freely rotate in either direction.

In one embodiment, the jackshaft pulleys 38, 44 (or comparable engagement mechanism) for the hydraulic motor 12 and internal combustion engine 16 can be free-spinning pulleys and can include a one-way clutch, which is designed to couple power into the jackshaft from the respective motor when power is applied in one direction, but to spin freely on the jackshaft otherwise. The jackshaft drive pulley 32 corresponding to the electric motor 14 can be a free-spinning pulley with an adjoining two-way magnetic clutch 58 that allows power from the electric motor to be selectively coupled into the jackshaft in either direction. As used herein, the term “free-spinning pulley” refers to a pulley that is mounted upon a bearing shaft and can freely spin in either direction (irrespective of the rotation of the shaft), until it is engaged with the shaft by a clutch or comparable mechanism. The device that engages the free-spinning pulley can be a one-way clutch that engages the pulley with the shaft only when the shaft rotates in one direction, or a two-way clutch that can engage in either direction. The use of a two-way clutch in connection with the electric motor is desirable to allow the vehicle to drive in reverse. With a simple change in current direction for the electric motor can be easily operated in reverse. This allows the electric motor to provide power for driving the vehicle in reverse.

The jackshaft is coupled to the input shaft 20 of the main transmission 22 via a coupler 60. The main transmission can be one of a wide variety of types of transmissions. In one embodiment, the main transmission is a variable transmission, such as a continuously variable transmission (CVT), which adjusts the “gear” ratio between the jackshaft and the main transmission output shaft 24 through an entire range of ratios between a maximum and minimum ratio. Where a variable transmission is used for the main transmission, it can include an electric drive motor 62 that adjusts the gearing ratio to provide the desired torque and speed characteristics for the drive wheel. While a variable transmission is particularly useful in this drive train, it will be appreciated that other types of transmissions can also be used for the main transmission, such as a geared automatic transmission.

Continuously variable transmissions have become more capable and widely used in recent years, and are commercially available and in use in a variety of motor vehicles. Unlike traditional automatic transmissions, CVTs do not have a gearbox with a set number of gears, which means they do not have interlocking toothed wheels. The most common type of CVT operates on a pulley system that allows an infinite variability between highest and lowest gear ratios with no discrete steps or shifts. While CVTs do not use gears, the term “gear ratio” is still used because, broadly speaking, a gear refers to a ratio of input shaft speed to output shaft speed. Although CVTs change this ratio without using a set of planetary gears, they are still described as having low and high “gears” or “gear ratios” for the sake of convention.

Most continuously variable transmissions only have three basic components: a high-power metal or rubber belt, a variable-input “driving” pulley, and an output “driven” pulley. In one embodiment, each pulley is made of two 20-degree cones facing each other. A belt rides in the groove between the two cones. V-belts are often used where the belt is made of rubber. When the two cones of the pulley are far apart (when the diameter increases), the belt rides lower in the groove, and the radius of the belt loop going around the pulley gets smaller. When the cones are close together (when the diameter decreases), the belt rides higher in the groove, and the radius of the belt loop going around the pulley gets larger.

The variable-diameter pulleys come in pairs. One of the pulleys, known as the input pulley or drive pulley, is connected to an input shaft, such as the crankshaft of an engine. The second pulley is called the driven pulley because the first pulley is turning it. As an output pulley, the driven pulley transfers energy to an output shaft, such as the driveshaft of a vehicle. When one pulley increases its radius, the other decreases its radius to keep the belt tight. As the two pulleys change their radii relative to one another, they create an infinite number of gear ratios—from low to high and everything in between. For example, when the pitch radius is small on the driving pulley and large on the driven pulley, then the rotational speed of the driven pulley decreases, resulting in a lower “gear.” When the pitch radius is large on the driving pulley and small on the driven pulley, then the rotational speed of the driven pulley increases, resulting in a higher “gear.” Thus, in theory, a CVT has an infinite number of “gears” that it can run through at any time, at any engine or vehicle speed.

The introduction of new materials in recent years has made CVTs more reliable and efficient. One of the most important advances has been the design and development of metal belts to connect the pulleys. These flexible belts are composed of several (e.g. nine or twelve) thin bands of steel that hold together high-strength, bow-tie-shaped pieces of metal. Metal belts don't slip and are highly durable, enabling CVTs to handle more engine torque. They are also quieter than rubber-belt-driven CVTs.

Continuously variable transmissions are becoming more popular because they provide several advantages that make them appealing. CVTs provide constant, stepless acceleration from a complete stop to cruising speed, which eliminates “shift shock” and provides a smoother ride. CVTs work to keep a vehicle motor in its optimum power range regardless of how fast the car is traveling, which leads to improved fuel efficiency. CVTs respond better to changing conditions, such as changes in throttle and speed, which eliminates gear hunting as a car decelerates, especially going up a hill. There is also less power loss in a continuously variable transmission than in a typical automatic transmission, which provides better acceleration. These types of transmissions also provide better control of a gasoline engine's speed range, which allows better control over emissions. They can also incorporate automated versions of mechanical clutches and thereby replace inefficient fluid torque converters.

Traditionally, belt-drive CVTs have been limited in the amount of torque they could handle, and have been larger and heavier than their automatic and manual counterparts. However, recent technological advances in belts have allowed CVTs to handle higher torque loads and made them smaller and more practical for higher-powered applications. These improvements in belt technology also apply to the drive train of the present invention, allowing the high torque belt and pulley system to interconnect the various motors and other elements of the system. Moreover, while a belt-type CVT has been described above, it will be appreciated that other types of CVTs are available and can be used. For example, torroidal and plate-and-bearing type CVTs have been developed and can be suitable for a hybrid vehicle drive train in accordance with the present disclosure.

Another type of variable transmission that can be used in the drive train disclosed herein is an infinitely variable transmission (IVT). An infinitely variable transmission is a type of variable transmission that operates in the same manner as a CVT, but includes low-end gearing ratios that achieve a zero output point. At this zero output point, the input shaft of the IVT can be rotating, while its output shaft is stationary. With a typical CVT, when the input shaft is rotating, the output shaft must also be rotating. The zero-point feature in an IVT is advantageous because it allows a drive motor to be operating at a high RPM prior to the acceleration of the vehicle. As a variable transmission, the main transmission 22 can be either a CVT or an IVT. As with CVTs, it will also be appreciated that a variety of types of IVTs have been developed and can be used in conjunction with a hybrid vehicle drive train in accordance with the present disclosure.

Referring back to FIG. 1, the configuration of magnetic clutches and pulleys allows each of the drive motors to independently apply power to the jackshaft 18 without causing the other pulleys on the jackshaft to be turned unnecessarily. For example, when the hydraulic motor 12 is engaged and the magnetic clutch 54 on the hydraulic motor is simultaneously engaged, the rotation of the hydraulic motor will be transferred to the jackshaft 18. However, with the other clutches disengaged, rotation of the jackshaft will not be transmitted via the pulleys and belts to the other two drive motors.

The combination of magnetic clutches on the electric motor 14 and jackshaft 18 allows the electric motor to be used for reversing the direction of the vehicle. When an operator desires to drive the vehicle in reverse, the electric motor can be rotated in the reverse direction (simply by reversing current to the motor), with the corresponding magnetic clutches on the electric motor and jackshaft engaged, thus transferring the reverse rotation of the electric motor to the jackshaft. However, the one-way clutches associated with the hydraulic motor pulley 38 and internal combustion engine pulley 44 will prevent reverse motion of the jackshaft to be transmitted to those other motors. Additionally, the magnetic clutches 54, 56 associated with the other motors can likewise prevent the transmission of reverse motion.

Advantageously, each of the three types of motors in the drive train of FIG. 1 has operating characteristics that make the motor well suited for some tasks and ill-suited for other tasks. By combining three motors in a single drive train, a vehicle designer can produce a vehicle that is more efficient because each motor can be used more closely to its most efficient operating condition. For example, hydraulic motors are well suited for low RPM, high-torque applications, and are frequently used in industrial machinery such as forklifts, backhoes, etc. Because of these characteristics, in various embodiments of hybrid vehicle drive trains disclosed herein, the hydraulic motor 12 is well suited for providing a brief period of high-torque/low RPM acceleration.

Internal combustion engines, on the other hand, are the least efficient of these three types of motors. However, internal combustion engines have the ability to create significant torque across a broad range of RPM, and also benefit from the wide availability and relatively high energy density of fossil fuels. These characteristics have helped to establish internal combustion engines as the standard for vehicular transportation. In many hybrid vehicles, an internal combustion engine still provides the prime motive power for the vehicle. However, an internal combustion engine can be used in a more subservient role. For example, viewing the embodiment of FIG. 1, the internal combustion engine 16 can be used as a helper motor, providing midrange acceleration and additional power for climbing, while the electric motor 14 is the prime mover. The internal combustion engine can also be used to provide onboard dump charging for batteries (not shown) for powering the electric motor. A relatively small internal combustion engine (around 20 HP) that can serve these functions is relatively fuel efficient in comparison to an internal combustion engine typically used in an economy car (100 HP+), yet it can provide substantial power assistance and up to 300 amps of charging power.

Electric motors, on the other hand, are most efficient when operating at a specific RPM (or within an RPM range) and under the precise load for which they were designed. Outside of this range the efficiency of the electric motor suffers. Because of these operating characteristics, the electric motor 14 in the various embodiments of this invention can be configured to be the primary drive motor for the vehicle, with its operating parameters maintained near optimum by the use of the main transmission. To preserve efficiency, the electric motor can be used sparingly for acceleration, with the hydraulic motor and internal combustion engine providing the bulk of accelerational power.

In the embodiment of FIG. 1, the main transmission 22 can operate in conjunction with the multiple motors to provide continuous output power to the drive shaft 26 throughout a full range of speed and power variation. For example, when the vehicle is to accelerate from a stop, the clutches 54, 38 associated with the hydraulic motor 12 can be engaged while the other motor clutches are disengaged, and the hydraulic motor can then be powered to provide high torque acceleration through the main transmission 22 to the drive wheel 28. By virtue of its design as a variable transmission, the main transmission can automatically vary the relative input and output gear ratios to couple the high torque of the hydraulic motor while within the low RPM range of that motor.

When the vehicle speed is such that powering it by the hydraulic motor 12 is no longer efficient (i.e. requires the hydraulic motor to rotate too fast), the electric motor 14 can be spooled up to a speed that will match the rotational speed of the jackshaft 18, and the respective clutches 52, 32 that are associated with the electric motor can then be engaged while the clutches associated with the hydraulic motor are disengaged, allowing the electric motor to take over the job of powering the vehicle. During this transition, the gear ratio of the main transmission 22 can be adjusted and the input clutch 58 associated with the main transmission can be engaged in a manner to minimize any jolt from the transition.

During normal driving of the vehicle, the main transmission 22 adjusts its gear ratio to provide the desired output speed and torque while keeping the rotational speed of the electric motor 14 closer to its most efficient operating range. During this phase of operation, the internal combustion engine 16 can be engaged (e.g. with a generator) to charge batteries or otherwise produce power that is used by the electric motor. However, when the vehicle encounters hills or other situations where additional power is required, and where the rotational speed forces the drive train out of the prime operating parameters for the electric motor, the internal combustion engine can be engaged to provide additional power. In such a situation, the internal combustion engine is revved up to a rotational speed matching the jackshaft 18, and the clutches 56, 44 associated with it are then engaged to transmit torque from the internal combustion engine to the jackshaft. This allows the mechanical power output of the internal combustion engine to be used to directly power the vehicle either alone (if the internal combustion engine alone has sufficient power) or in combination with the electric motor. Once the need for additional power has passed, the internal combustion engine clutches can be disengaged, and propulsion of the vehicle can revert to the electric motor alone.

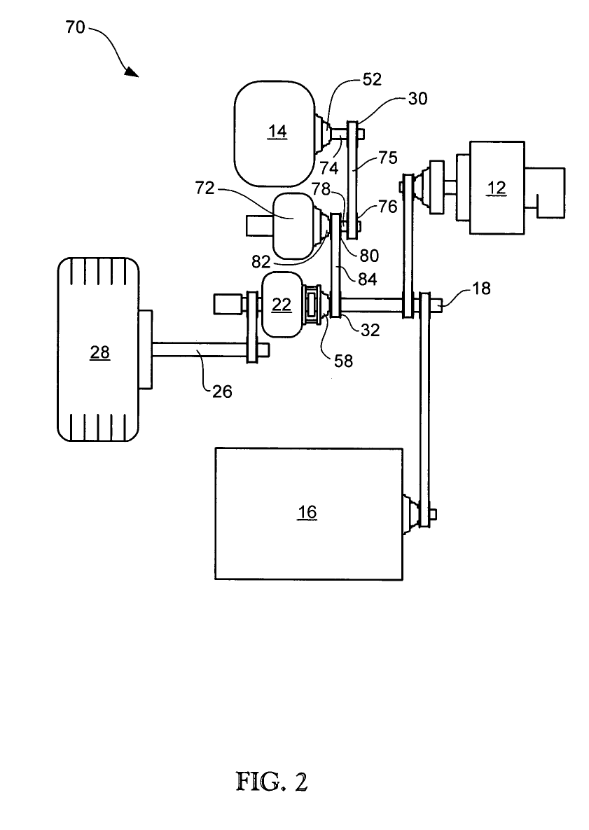

The embodiment of FIG. 1 includes a single main transmission 22, which is used in conjunction with a series of clutches to engage or disengage the various motors at different rotational speeds of the jackshaft. This allows the drive train to use the various motors in conditions as close as possible to their most efficient operating parameters. However, the advantages of a variable transmission can also be used to modulate the output of a given motor relative to the jackshaft itself. Shown in FIG. 2 is an alternative embodiment of a hybrid vehicle drive train 70 that includes a second variable transmission 72 positioned between the electric motor 14 and the main transmission 22. The pulley 30 that is affixed to the drive shaft 74 of the electric motor is connected via a V-belt 75 with a corresponding pulley 76 that is affixed to the input shaft 78 of the second variable transmission. A free-spinning pulley 80 is attached to the output sleeve (not visible) of the second transmission. This free-spinning pulley interacts with a magnetic clutch 82 associated with the second transmission, and is connected via a V-belt 83 to the pulley 32 attached to the jackshaft 18 and main transmission.

The second transmission 72 in this embodiment modulates any difference in RPM between the electric motor 14 and the jackshaft 18. Such modulation can be desirable when multiple motors are engaged with the jackshaft simultaneously, and can also be desirable with some types of motor control circuits. For example, with some types of control circuits the electric motor is accelerated to peak without a load, and is then engaged through the second variable transmission. The main transmission 22 is then used to transmit the torque to the vehicle.

The second variable transmission 72 can be a continuously variable transmission (CVT) or an infinitely variable transmission (IVT). Use of an IVT allows the second variable transmission to function as both a transmission and a clutch. The second variable transmission allows the electric motor 14 to be accelerated to peak (e.g. 4,000 RPM) prior to engaging with the main transmission 22, even though the input on the main transmission may be spinning much slower (e.g. 2,000 RPM). In other words, the input for the second variable transmission can be spinning at the RPM of the electric motor, while the output of the second variable transmission can be spinning at a rate identical to the RPM of the jackshaft 18 (which is the same as the input to the main transmission).

In practical application, this embodiment works as follows. To accelerate from a stop, the operator depresses an accelerator pedal (not shown), which can engage the hydraulic motor 12. As the hydraulic motor is engaged, the main transmission 22 will begin to adjust to increase the vehicle's speed. A short time (e.g. a few seconds) into the acceleration, the hydraulic storage (high pressure fluid powering the hydraulic motor) may be depleted. At that point, the hydraulic motor may be spinning at, e.g., 2,000 RPM, with the vehicle traveling at 20 mph.

Just prior to the depletion of hydraulic energy, the electric motor 14 is accelerated to peak, say 4,000 RPM. The main transmission 22 can be geared, for example, to provide an output speed of 20 mph at 2,000 RPM at this instant, while the electric motor is spinning at 4,000 RPM. The second variable transmission 72 takes the 4,000 RPM of the electric motor and gears it down to 2,000 RPM. The second variable transmission and the main transmission then work in tandem to bring the vehicle up to the operator's desired speed, based on input from the accelerator. If the electric motor, working with the two variable transmissions, is not able to accelerate the vehicle up to speed without falling too far out of peak operating range, the internal combustion engine 16 can be engaged to assist with acceleration.

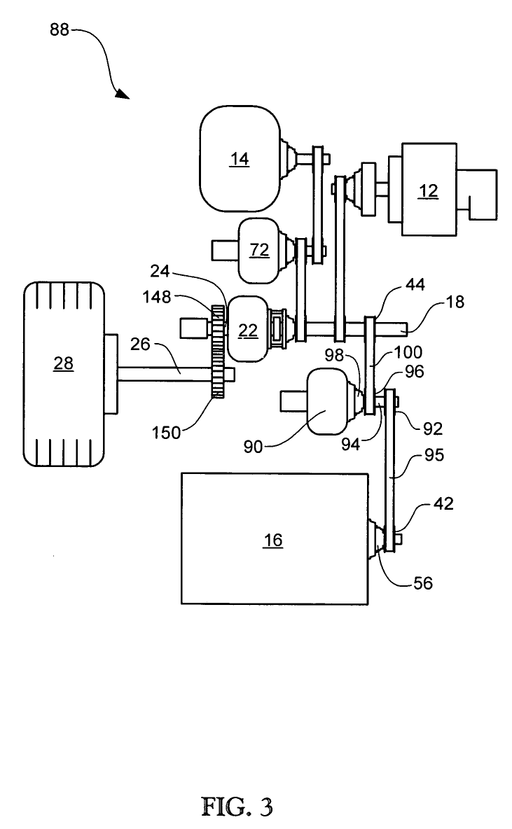

The advantages of an additional variable transmission can also be applied to the other motors in the drive train. Shown in FIG. 3 is another embodiment of a hybrid vehicle drive train 88 that includes the second variable transmission 72 as in FIG. 2, and a third variable transmission 90 positioned inline between the internal combustion engine 16 and the main transmission 22. The drive pulley 42 of the internal combustion engine is attached to a pulley 92 that is attached to the input shaft 94 of the third transmission via a V-belt 95. A free-spinning pulley 96 is attached to the output sleeve (not visible) of the third transmission. This free-spinning pulley interacts with a magnetic clutch 98 and transmits rotation to the jackshaft pulley 44 via another V-belt 100.

As with the second variable transmission 72, the third variable transmission 90 modulates rotational speed between the internal combustion engine 16 and the jackshaft 18. Also like the second variable transmission, the third variable transmission can be a CVT or an IVT having a zero point that allows the input shaft to rotate without the output shaft rotating at the same time. Once again, use of an IVT in this position allows the third variable transmission to function as both a transmission and a clutch.

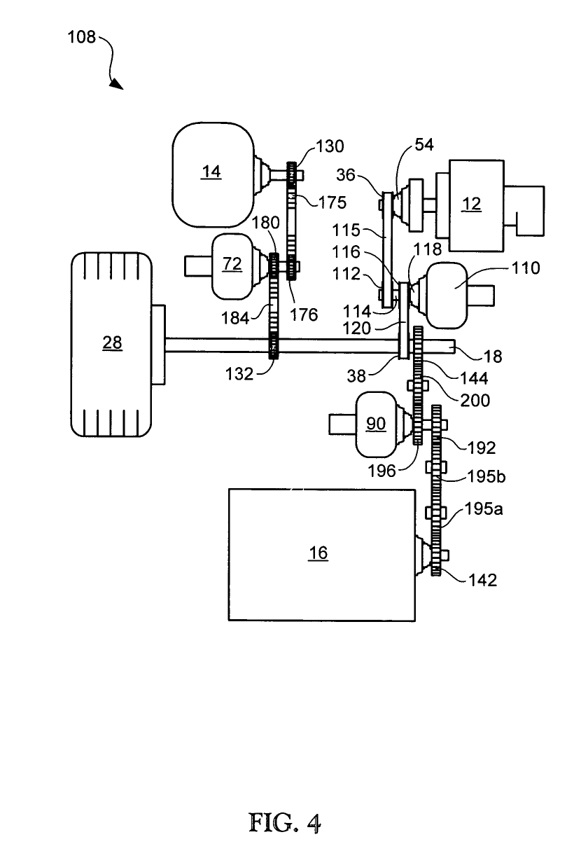

Shown in FIG. 4 is yet another alternative embodiment of a hybrid vehicle drive train 108 in which there is no main transmission, and wherein a fourth variable transmission 110 is positioned inline between the hydraulic motor 12 and the jackshaft 18. In this embodiment the drive pulley 36 of the hydraulic motor 12 is attached to a pulley 112 that is attached to the input shaft 114 of the fourth variable transmission via a V-belt 115. A free-spinning pulley 116 is attached to the output sleeve (not visible) of the fourth transmission. This free-spinning pulley interacts with a magnetic clutch 118 and transmits rotation to the jackshaft pulley 38 via another V-belt 120.

As with the other embodiments discussed above, the fourth variable transmission 110 modulates rotational speed between the hydraulic motor 12 and the jackshaft 18. Also like the other embodiments discussed above, the fourth variable transmission can be a CVT or an IVT, in which case the fourth transmission can function as both a transmission and a clutch. Use of an IVT for the fourth variable transmission is most valuable in this drive train where it is intended that the hydraulic motor be used to accelerate the vehicle from a stop. An IVT in this position allows the input shaft of the fourth variable transmission to rotate without the output shaft rotating at the same time. This allows the hydraulic transmission to rev up and generate torque with the IVT at the zero point, before rotation of the jackshaft begins, so that the hydraulic motor can reach its optimum operating speed before a load is placed upon it.

As noted, the embodiment of FIG. 4 does not include a main transmission attached to the jackshaft 18. Instead, the jackshaft itself serves as a drive shaft, and directly drives the drive wheel 28. This is possible because a separate transmission is associated with each motor in the drive train. Each transmission modulates the rotational speed of the respective motor to match the jackshaft, and thereby transmits torque to the jackshaft in its proper rotational speed range.

The embodiments shown in FIGS. 1 and 2 employ belt and pulley systems to couple each of the various components of the drive train. However, a hybrid vehicle drive train in accordance with this disclosure can be coupled in other ways, and multiple coupling mechanisms can be mixed in a single embodiment. For example, in the embodiment shown in FIG. 4, the hydraulic motor 12 is coupled to the jackshaft 18 via a belt and pulley system as described above. However, the electric motor 14 is coupled to the jackshaft by a sprocket and chain system. The drive shaft of the electric motor includes a sprocket 130 that is connected via an endless chain 175 to a corresponding sprocket 176 that is affixed to the input shaft of the second variable transmission 72. Another sprocket 180 is attached to the output sleeve (not visible) of the second transmission, and this free-spinning sprocket is connected via an endless chain 184 to a sprocket 132 attached to the jackshaft.

As another alternative to a pulley and belt coupling system, the hybrid vehicle drive train components can be coupled using gears. As shown in FIG. 4 the internal combustion engine 16 can include a drive gear 142 that is coupled to an input gear 192 of the second variable transmission 90 via a first series of idler gears 195a, 195b. The second variable transmission also includes an output gear 196 that transmits rotational force to the corresponding gear 144 on the jackshaft 18 via a second idler gear 200. Similarly, in the embodiment of FIG. 3, the output shaft 24 of the main transmission 22 includes a spur gear 148 that is connected to a corresponding gear 150 on the drive shaft 26.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A drive train for a hybrid vehicle having first, second and third motors, comprising:
a first variable transmission, having an input shaft and an output shaft, the output shaft being coupled to a drive wheel of the vehicle; and
first, second, and third clutched rotational drive connections, selectively interconnecting an output shaft of the first, second and third motors, respectively, with the input shaft of the first transmission, whereby torque from each of the three motors can be selectively combined through the variable transmission to drive the drive wheel.

2. A drive train in accordance with claim 1, wherein the first variable transmission comprises a continuously variable transmission.

3. A drive train in accordance with claim 1, wherein the first, second and third clutched rotational drive connections are selected from the group consisting of: a pulley and endless belt system, a chain and sprocket system, and a gear system.

4. A drive train in accordance with claim 1, wherein the first, second and third motors are selected from the group consisting of an internal combustion engine, an electric motor, and a hydraulic motor.

5. A drive train in accordance with claim 1, further comprising at least one additional variable transmission, interposed within at least one of the first second and third rotational drive connections, configured to match a speed of rotation of at least one of the first second and third motors with a speed of rotation of the input shaft of the first transmission.

6. A drive train in accordance with claim 5, wherein the at least one additional variable transmission comprises an infinitely variable transmission.

7. A drive train in accordance with claim 1, wherein the first variable transmission comprises a continuously variable transmission, and further comprising:
a second variable transmission, interposed within the first rotational drive connection, configured to match a speed of rotation of the first motor with a speed of rotation of the input shaft of the first transmission; and
a third variable transmission, interposed within the second rotational drive connection, configured to match a speed of rotation of the second motor with a speed of rotation of the input shaft of the first transmission.

8. A drive train for a hybrid vehicle having first, second and third motors, comprising:
a drive shaft, connected to a drive wheel of the vehicle;
first, second, and third rotational drive connections, selectively interconnecting an output shaft of the first, second and third motors, respectively, with the drive shaft; and
first, second, and third variable transmissions, interposed within the first second and third rotational drive connections, respectively, configured to match a speed of rotation of the respective motor with a speed of rotation of the drive shaft, whereby torque from each of the three motors can be selectively combined through the variable transmission to drive the drive wheel.

9. A drive train in accordance with claim 8, wherein at least one of the first, second and third variable transmissions comprise an infinitely variable transmission.

10. A drive train in accordance with claim 8, wherein the first, second and third motors are selected from the group consisting of an internal combustion engine, an electric motor, and a hydraulic motor.

11. A drive train in accordance with claim 8, wherein the first, second and third rotational drive connections are selected from the group consisting of: a pulley and endless belt system, a chain and sprocket system, and a gear system.

12. A hybrid vehicle drive train, comprising:
a first variable transmission, having an input shaft, and an output shaft coupled to a drive wheel of the vehicle;
a plurality of motors, independently operable at varying rotational rates; and
means for selectively coupling an output shaft of each of the plurality of motors to the input shaft of the first transmission, whereby torque from each of the plurality of motors can be selectively independently combined through the first transmission to drive the drive wheel.

13. A hybrid vehicle drive train in accordance with claim 12, wherein the plurality of motors are selected from the group consisting of an internal combustion engine, an electric motor, and a hydraulic motor.

14. A hybrid vehicle drive train in accordance with claim 12, wherein the means for coupling each of the plurality of motors comprises at least one additional variable transmission, associated with at least one of the plurality of motors, configured to match a speed of rotation of the at least one motor with a speed of rotation of the input shaft of the first transmission.

15. A hybrid vehicle drive train in accordance with claim 14, wherein the at least one additional variable transmission comprises an infinitely variable transmission.

16. A hybrid vehicle drive train in accordance with claim 12, wherein the means for coupling each of the plurality of motors is selected from the group consisting of: a pulley and endless belt system, a chain and sprocket system, and a gear system.

17. A hybrid vehicle drive train in accordance with claim 12, wherein the first variable transmission comprises a continuously variable transmission.

18. A method for interconnecting multiple torque sources operating at independent speeds to drive a common output shaft, comprising the steps of:
interconnecting each of the multiple torque sources to a common input shaft via an individual clutched rotational drive connection associated with each torque source; and
modulating rotation of the output shaft via a variable transmission connected to the common input shaft, whereby torque from each of the multiple torque sources can be selectively combined through the variable transmission to drive the common output shaft.

19. A method in accordance with claim 18, further comprising the step of modulating rotation of the clutched rotational drive connection of at least one of the multiple torque sources via a variable transmission to match a rotational speed of the common input shaft.

20. A method in accordance with claim 18, further comprising the step of selectively independently modulating rotation of the clutched rotational drive connection of two of the multiple torque sources via a variable transmission to match a rotational speed of the common input shaft.
